(19) United States
(12) Patent Application Publication
(10) Pub. No.: US 2023/0104188 A1
(43) Pub. Date: Apr. 6, 2023

(54) METHOD, APPARATUS, AND SYSTEM FOR CALIBRATING VEHICLE MOTION DATA BASED ON MOBILE DEVICE SENSOR DATA

(71) Applicant: HERE Global B.V., Eindhoven (NL)

(72) Inventors: Silviu ZILBERMAN, Rishon Le-Zion (IL); Harel PRIMACK, Rishon Le-Zion (IL)

(21) Appl. No.: 17/488,170

(22) Filed: Sep. 28, 2021

(51) Int. Cl. B60W 50/00; G01P 21/00

(52) U.S. Cl. CPC B60W 50/00; G01P 21/00; B60W 2050/0083; B60W 2556/10; B60W 2520/105; B60W 2520/125; B60W 2520/06

(57) ABSTRACT

An approach is provided for calibrating vehicle motion data using a rotation matrix calculated based on mobile device sensor data, thereby determining vehicle events (e.g., forward acceleration, stoppages, etc.). The approach, for example, involves determining a road segment that meets one or more criteria for straightness, inclination, or a combination thereof. The approach also involves collecting sensor data from at least one sensor of a mobile device associated with a vehicle in motion on the road segment based on the determination. The sensor data indicates one or more acceleration vectors in a mobile device frame of reference. The approach further involves calibrating the one or more acceleration vectors from the mobile device frame of reference to a vehicle frame of reference based on the sensor data. The approach further involves providing the one or more calibrated acceleration vectors as an output.

### BACKGROUND

Many mapping, navigation, and/or other location-based services rely on knowing the location, speed, velocity, and/or acceleration of a vehicle to determine vehicle events such as starting a car, stopping, passenger on/off boarding, car turning, taking a ramp, breaking or accelerating and so on. Generally, the vehicle location, speed, velocity, and/or acceleration can be measured by or inferred from using Global Positioning System (GPS) data or other equivalent positioning technologies (e.g., other Global Navigation Satellite Systems— GNSS), location technologies such as cellular or Wi-Fi triangulation, and/or by using dedicated sensors of the vehicle. However, such sensors may be malfunctioning, unavailable, and/or inaccessible, and satellite-based positioning may become unavailable because of signal interference, loss of line-of-sight to orbiting satellites, etc., to provide such mapping, navigation, and/or other location-based services. As a result, service providers face significant technical challenges to determine the location, speed, and/or velocity of the vehicle when only a mobile device is available in the vehicle.

### SOME EXAMPLE EMBODIMENTS

Therefore, there is a need for an approach for calibrating vehicle motion data (e.g., speed, velocity, forward/backward acceleration, stoppages, etc.) based on mobile device sensor data, such as from smart phones.

According to one embodiment, a method comprises determining a road segment that meets one or more criteria for straightness, inclination, or a combination thereof. The method also comprises collecting sensor data from at least one sensor of a mobile device associated with a vehicle in motion on the road segment based on the determination. The sensor data indicates one or more acceleration vectors in a mobile device frame of reference. The method further comprises calibrating the one or more acceleration vectors from the mobile device frame of reference to a vehicle frame of reference based on the sensor data. The method further comprises providing the one or more calibrated acceleration vectors as an output.

According to another embodiment, an apparatus comprises at least one processor, and at least one memory including computer program code for one or more computer programs, the at least one memory and the computer program code configured to, with the at least one processor, cause, at least in part, the apparatus to determine a road segment that meets one or more criteria for straightness, inclination, or a combination thereof. The apparatus is also caused to collect sensor data from at least one sensor of a mobile device associated with a vehicle in motion on the road segment based on the determination. The sensor data indicates one or more acceleration vectors in a mobile device frame of reference. The apparatus is further caused to calibrate the one or more acceleration vectors from the mobile device frame of reference to a vehicle frame of reference based on the sensor data. The apparatus is further caused to provide the one or more calibrated acceleration vectors as an output.

According to another embodiment, a computer-readable storage medium carries one or more sequences of one or more instructions which, when executed by one or more processors, cause, at least in part, an apparatus to determine a road segment that meets one or more criteria for straightness, inclination, or a combination thereof. The apparatus is also caused to collect sensor data from at least one sensor of a mobile device associated with a vehicle in motion on the road segment based on the determination. The sensor data indicates one or more acceleration vectors in a mobile device frame of reference. The apparatus is further caused to calibrate the one or more acceleration vectors from the mobile device frame of reference to a vehicle frame of reference based on the sensor data. The apparatus is further caused to provide the one or more calibrated acceleration vectors as an output.

According to another embodiment, an apparatus comprises means for determining a road segment that meets one or more criteria for straightness, inclination, or a combination thereof. The apparatus also comprises means for collecting sensor data from at least one sensor of a mobile device associated with a vehicle in motion on the road segment based on the determination. The sensor data indicates one or more acceleration vectors in a mobile device frame of reference. The apparatus further comprises means for calibrating the one or more acceleration vectors from the mobile device frame of reference to a vehicle frame of reference based on the sensor data. The apparatus further comprises means for providing the one or more calibrated acceleration vectors as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of calibrating vehicle motion data using a rotation matrix calculated based on mobile device sensor data, according to one embodiment;

FIG. 2A is a flowchart of a calibration process, according to one embodiment;

FIGS. 2B-2E are graphs illustrating example mobile device locations in a vehicle, according to various embodiments;

FIGS. 2F-2H depict example frames of reference and rotation matric for determining vehicle events, according to various embodiments;

FIG. 3 is a diagram of a vehicle event module/vehicle event platform capable of calibrating vehicle motion data using a rotation matrix calculated based on mobile device sensor data, according to one embodiment;

FIG. 4 is a flowchart of a process for calibrating vehicle motion data using a rotation matrix calculated based on mobile device sensor data, according to one embodiment;

FIG. 5 is a diagram of an example user interface showing a vehicle event, according to one embodiment;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal that can be used to implement an embodiment.

### DESCRIPTION OF SOME EMBODIMENTS

Examples of a method, apparatus, and computer program for determining vehicle events are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

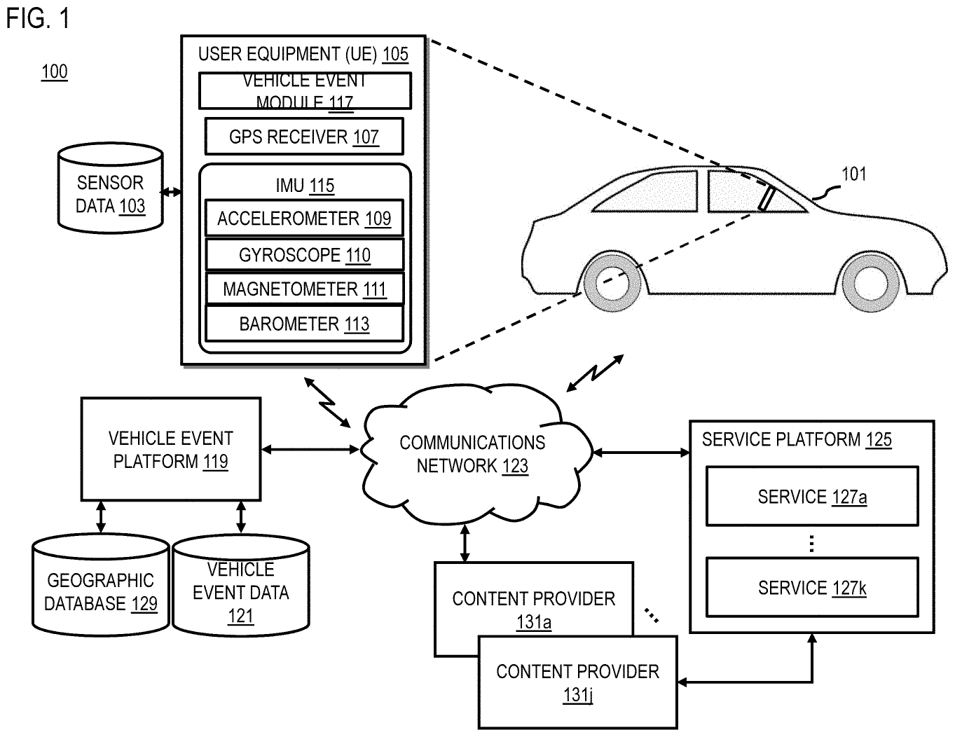

FIG. 1 is a diagram of a system capable of calibrating vehicle motion data using a rotation matrix calculated based on mobile device sensor data, according to one embodiment. Embodiments of the technology described herein relate to calibrating vehicle motion data using mobile device sensor data, thereby estimating a vehicle event (e.g., forward acceleration, braking, etc.). As mentioned, vehicle sensors may be malfunctioning, unavailable, and/or inaccessible for determining vehicle velocity, acceleration, and/or vehicle events (e.g., forward/reveres acceleration, stoppages, etc.). For example, although the global automotive sensors have been increasing from the growing popularity of self-driving cars across the world, some vehicles are not equipped with such dedicated sensors (e.g., in rural and/or developing areas). As other examples, GNSS data (e.g., GPS) may be unavailable (e.g., when the receiver is traveling in tunnels, underground, indoor, etc.), sparsely available (e.g., due to local interferences or weak satellite signals), or very inaccurate (e.g., near high-rise buildings).

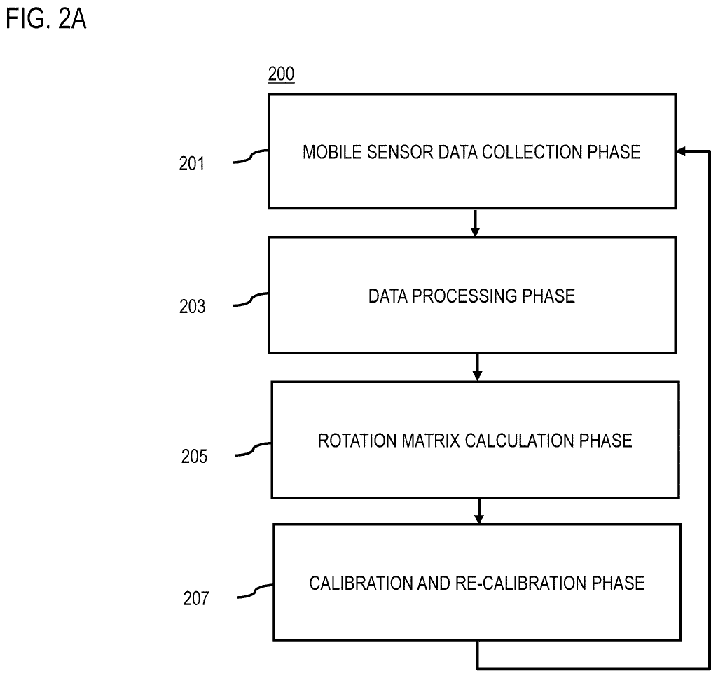

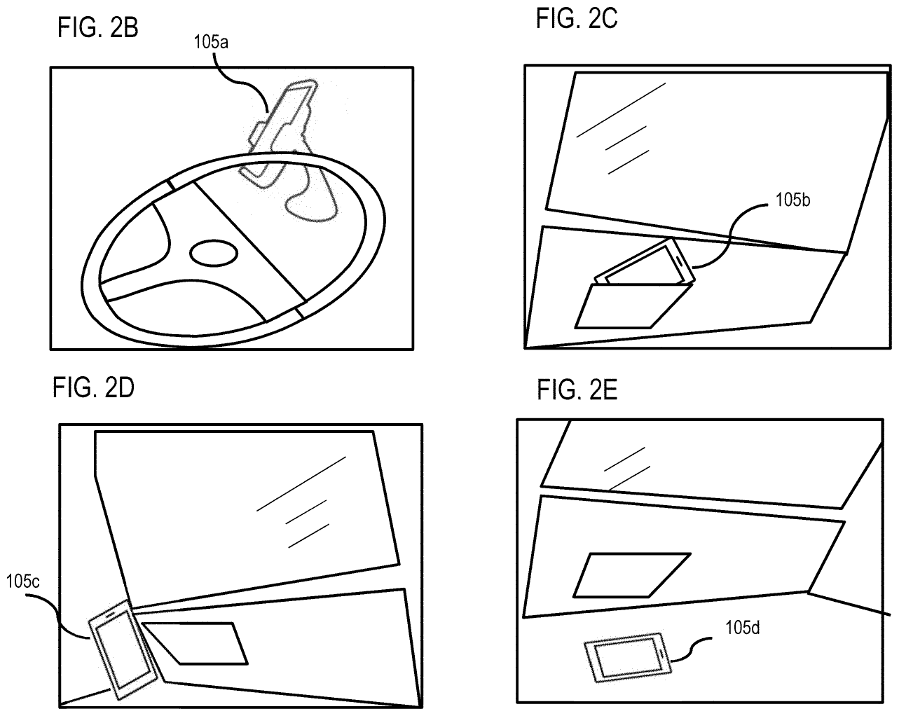

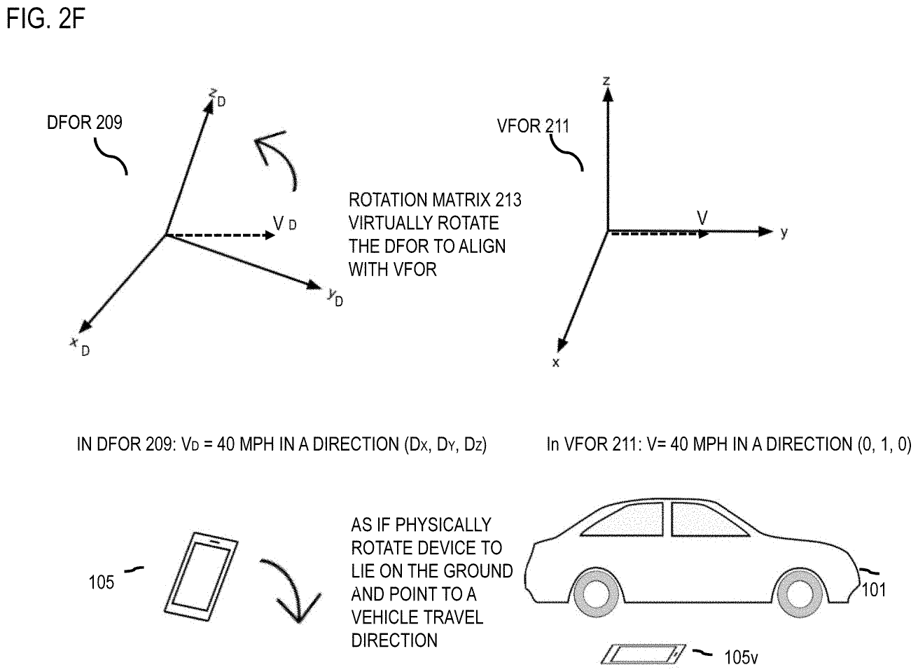

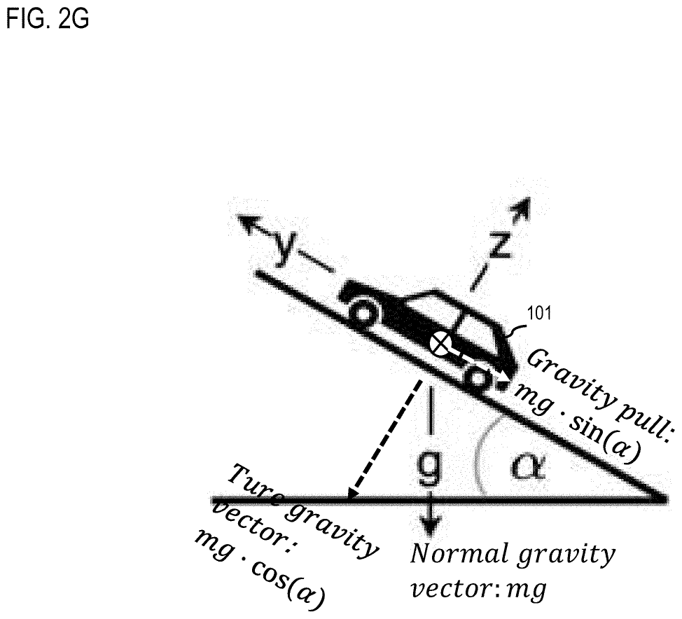

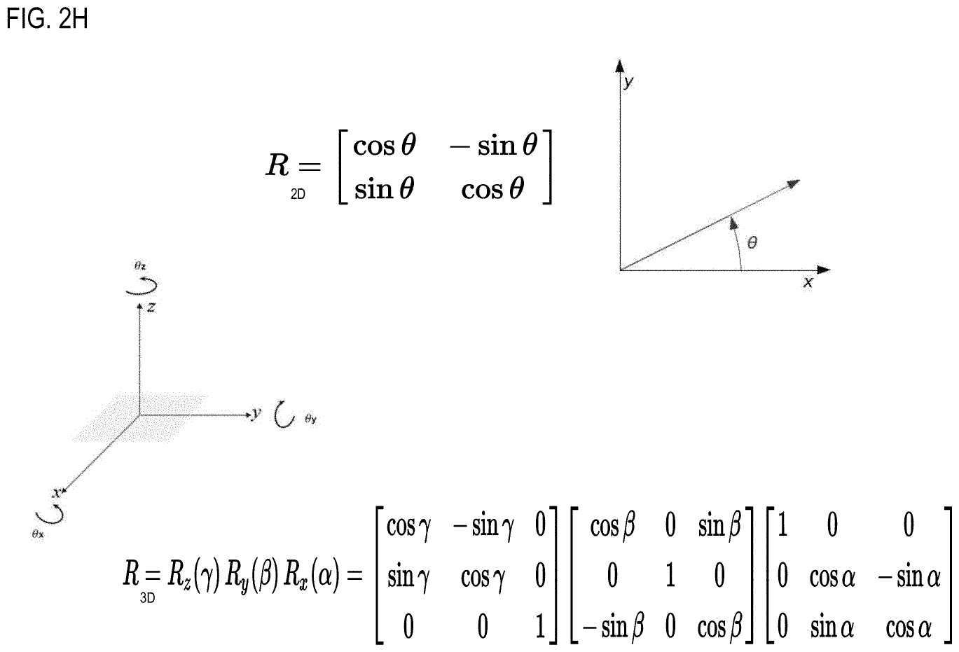

To address the technical challenges related to determining events of a vehicle (e.g., a vehicle 101) in the absence of vehicle sensors and/or vehicle sensor data, the system 100 of FIG. 1 introduces a capability of calculating a rotation matrix based on sensor data 103 from a mobile device and then using the rotation matrix to project the sensor data 103 in a mobile device frame of reference (DFOR) to a vehicle frame of reference (VFOR), i.e., calibrating vehicle motion data from DFOR to VFOR. FIG. 2A is a flowchart of a calibration process 200, according to one embodiment. In one embodiment, the calibration process 200 can include a mobile sensor data collection phase 201, a data processing phase 203, a rotation matrix calculation phase 205, and a calibration and re-calibration phase 207. The calibration process can start immediately when a vehicle ride starts and repeats (i.e., re-calibrate) as more mobile sensor data is collected.

Generally, modern mobile devices are equipped with multiple sensing units such as GNSS, IMU, pressure sensors, proximity sensors, etc. These sensors allow for determination of position, acceleration, magnetic field, angular rotation rate, and in theory, one can use those measurement to know the exact position, velocity, acceleration and orientation of the device at any time thereby inferring the location, speed, velocity, acceleration, and/or events of a vehicle carrying the mobile device. In one embodiment, the mobile device is a user equipment (UE) device 105 (e.g., a smartphone, a fitness tracker, a gaming or virtual reality wearable or equivalent mobile device, etc.) travelling with the vehicle 101.

The vehicle event detection using mobile device sensors yet requires known orientation of the mobile device with respect to the vehicle 101. Nevertheless, the orientation of the mobile device are not always known. FIGS. 2B-2E are graphs illustrating example mobile device locations in a vehicle 101, according to various embodiments. By way of example, FIG. 2B shows a UE 105a sits in a holder in the vehicle 101. As another example, FIG. 2C shows a UE 105b sits in a passage side door pocket. FIG. 2D shows a UE 105c lies on a back seat of the vehicle 101, and FIG. 2E shows a UE 105a lies on a floor of the vehicle 101. In one embodiment, the system 100 can infer vehicle location, speed, velocity, acceleration, and/or vehicle events using mobile device sensor data without the knowledge of the orientation and location of the mobile device with respect to the vehicle 101.

For instance, the UE 105 can contain one or more location sensors (e.g., a GPS receiver 107), one or more acceleration sensors (e.g., an accelerometer 109), one or more gyroscopes 110 one or more magnetic field meters (e.g., a magnetometer 111), etc. In one embodiment, the accelerometer 109, the gyroscope 110, and/or the magnetometer 111 may be included in an inertial measurement unit (IMU) 115 along with other sensors such as, but not limited to, one or more atmospheric pressure meters (e.g., a barometer 113). The GPS receiver 107 is used as an example. The broader category would be the global navigation satellite systems (GNSS), such as GPS, GALILEO, GLONASS and BEIDOU. Further, positioning can be performed using a combination of GNSS and Radio Signal based systems, such as WiFi, Bluetooth, Bluetooth low energy, 2/3/4/5G cellular signals, ultra-wideband (UWB) signals, etc. of the UE 105.

In one embodiment, when the UE 105 is fixed to the vehicle 101 at an unknown position and orientation relative to the vehicle 101, the system 100 (e.g., via a vehicle event module 117 local to the UE 105 and/or via a vehicle event platform 119 on the network side) can calculate a rotation matrix R based on the sensor data 103 from the UE 105, then use the rotation matrix R to project vehicle event measurement vector(s) (e.g., speed vector, acceleration vectors, etc.) in a device frame of reference to a vehicle frame of reference for the vehicle 101 according to the following equation (1). The system 100 then can derive/detect a vehicle event (e.g., a forward acceleration) of the vehicle based on the projected vehicle event measurement vector(s).

v_{vehicle}=R(DFOR→VFOR)v_{device} (1)

When a mobile device is placed in the vehicle 101, the axes of the UE 105 and the vehicle 101 generally do not overlap (e.g., FIGS. 2B-2E), the road may not be completely horizontal, and the rotation matrix R between those two sets of coordinates is apriori unknown. FIGS. 2F-2G depict example frames of reference and rotation matric for determining vehicle events, according to various embodiments. In FIG. 2F, a device frame of reference (DFOR) 209 has axes XD, YD, and ZD, while a vehicle frame of reference (VFOR) 211 has axes X, Y, and Z. The system 100 can assume the UE 105 as stationary with respect to the vehicle 101, then calculate the rotation matrix R between DFOR and VFOR, i.e., the rotation matrix R calibrating vectors from DFOR to VFOR. When the UE 105 moves to a different position and/or orientation in the vehicle 101, the system 100 can re-calculate the rotation matrix R accordingly.

For instance, the mobile device sensor data 103 can be collected while the vehicle 101 is in forward motion. Starting from an idle state, if the motion lasts more than a few seconds, then the system 100 can assume that the vehicle 101 is in a forward motion. A vehicle idle state can be vehicle stop with engine off, vehicle idle with engine on, etc., to be determined via vehicle and/or mobile device sensors, such as use determining vibrations cause by a vehicle engine (e.g., an internal combustion engine) based on accelerometer and/or gyroscope data.

By way of examples, the sensor data 103 may come from the GPS receivers 107, the accelerometer 109, the magnetometer 111, the barometer 113, other components of the IMU 115. The GPS receiver 107 can measure location information (e.g., geographic coordinates). The accelerometer 109 can measure acceleration, as a(t)=[ax, ay, az]. The barometer 113 can measure an altitude h(t), as pressures varies with altitude. The magnetometer 111 usually have the lowest operation frequency and can output m(t)=[mx, my, mz]. In other embodiments, other sensors (e.g., microphones, light sensors, etc.) of the UE 105 capable of detecting an environment characteristic or condition that can be used to characterize a vehicle event can also be used in addition to, in combination with, or in place of the GPS receiver 107, the accelerometer 109, the barometer 113, and the magnetometer 111.

In one embodiment, the system 100 can detect and/or quantify vehicle turns by (1) following the trajectory of the vehicle 101 using location sensors, or (2) obtaining a rotation vector from a DFOF to a VFOR, thereby obtaining the azimuthal and inclination angle. To simply the calculation, the system 100 can restrict vehicle movements to a single vehicle travel direction (e.g., a straight line such as they axis of the VFOR 211) without lateral forces (such as from taking turns and/or lane changes), and/or on a slope with a constant or substantially constant inclination angle during the mobile sensor data collection phase 201.

In one embodiment, the system 100 can selectively collect mobile device sensor data when the vehicle 100 is traveling on relatively straight stretches/segments of a road and/or on a slope with a constant or substantially constant inclination angle. For instance, the system 100 can retrieve map data from a map database to determine the relatively straight road segments and/or the slope with a near constant inclination angle, for collecting the mobile device sensor data. When the map data is unavailable, the system 100 can use location sensor data of the vehicle 101 and/or the UE 105, to determine the relatively straight road segments and/or the slope with a near constant inclination angle, for collecting the mobile device sensor data. When the location sensor data has only the latitude and longitude components but not altitude components, the system 100 can apply barometer data as altimeter, to calculate the rotation matrix R.

In another embodiment, the system 100 can collect all mobile device sensor data then exclude the data points collected under undesirable conditions, such as during turns and/or lane changes, on a slope with variable gradients, etc., from calculating the rotation matrix R. For instance, the system 100 can (1) identify and/or quantify vehicle turns by following the trajectory of the vehicle 101 using location sensors, (2) identify lane changes (each of which includes two opposite small turn events); (3) filter out the stretches of road exhibit some angular velocity (e.g., measured by a gyroscope), and/or (4) filter out slopes with variable gradients (e.g., measured by a barometer/altimeter).

After the mobile sensor data collection phase 201, the system 100 can execute the data processing phase 203, the rotation matrix calculation phase 205, and the calibration and re-calibration phase 207. For instance, after collecting the sensor data 103 from the UE 105 over relatively straight road segment(s) and/or on a slope with a constant or substantially constant inclination angle, the system 100 can calculate a rotation matrix for calibrating mobile device sensor data from the DFOR 209 to the VFOR 211.

For instance, the sensor data 103 can include pairs of time-matching datapoints of velocity vectors (\vec{v}_{loc}, \vec{v}ᵢₘᵤ) measured using the GPS sensor 107 and the accelerometer 109 of the UE 105 under the above-discussed desirable conditions. The magnitudes of the velocity vectors in each pair should be similar, since they were captured approximately the same time, although there may be measurement and numerical errors, as well as different sensor data sampling rates. In one embodiment, the system 100 can exclude outlying datapoints, and then average the pair of the datapoints and/or a plurality pairs of datapoints to get an average velocity vector \vec{v}ₐᵥ in DFOR 209, and use the average velocity vector \vec{v}ₐᵥ in DFOR 209 as a stable velocity \vec{v}ₐ along a travel direction D (Dx, Dy, Dz) in the DFOR 209.

In this instance, when the vehicle 101 moves at a stable velocity v in VFOR 211, e.g., 40 mph along a travel direction (0, 1, 0), the velocity v can be expressed \vec{v} (0, v, 0) in VFOR 211. As the \vec{v} is known and \vec{v}_{average} is calculated as the \vec{v}_{d}, the system 100 can calculate the rotation matrix R based on the equation (1): \vec{v}=R\vec{v}_{average}

An average velocity vector \vec{v}ₐᵥ is the ratio of the displacement to the time interval for the displacement, which is different from \vec{v}_{average}. An velocity vector \vec{v}, or more precisely an instantaneous velocity vector, is the limit of the average velocity as Δt approaches zero. Its direction is along the travel direction.

By analogy, the sensor data 103 can include pairs of time-matching datapoints and/or a plurality pairs of datapoints of acceleration vectors (\vec{a}_{loc} \vec{a}ᵢₘᵤ), etc. measured using the GPS sensor 107 and the accelerometer 109 of the UE 105.

By way of example, the magnitudes of the acceleration vectors in each pair should be similar since they were captured approximately the same time, although there may be measurement and numerical errors, as well as different sensor data sampling rates. When the vehicle 101 moves at a stable speed along the travel direction, the time-matching datapoints of acceleration vectors (\vec{a}_{loc}, \vec{a}ᵢₘᵤ) of different pairs should be similar as well.

\vec{a}(t)=Δ\vec{v}(t)/Δt (2)

In one embodiment, the system 100 can exclude outlying datapoints, and then average the pair of the datapoints and/or a plurality pairs of datapoints to get an average acceleration vector \vec{a}ₐᵥ in DFOR 209, and use the average acceleration vector \vec{a}ₐᵥ in DFOR 209 as a stable acceleration \vec{a}ₐ along a travel direction D (Dx, Dy, Dz) in the DFOR 209.

In this instance, when the vehicle 101 moves at a stable acceleration a in VFOR 211, e.g.,

$$2 \frac{m}{{s}^{2}}$$

along a travel direction (0, 1, 0), the acceleration a can be expressed \vec{a}(0, a, 0) in VFOR 211. As the \vec{a} is known and \vec{a}_{average} is calculated as the \vec{a}_{d}, the system 100 can calculate the rotation matrix R based on the following equation:

\vec{a}=R\vec{a}_{average} (3)

An average acceleration vector \vec{a}ₐᵥ is defined as the rate at which the velocity changes, which is deferent from \vec{a}_{average}. \vec{a}ₐᵥ is in the direction of the change in velocity Av, and the acceleration a is an instantaneous acceleration that is the limit of the average acceleration aav as Δt approaches zero.

In another scenario, the system 100 can consider when the vehicle 101 is driving on a slope with a local gradient or inclination angle such that the z-axis of the vehicle 101 and the earth surface are to perpendicular to each other. In FIG. 2G, the vehicle frame of reference has axes X, Y, and Z, and the system 100 can assume that the slope has a constant or substantially constant inclination angle α, and that the UE 105 is stationary with respect to the vehicle 101. The system 100 can then calculate a rotation matrix R for calibrating vectors from DFOR to VFOR considering the inclination angle α. The system 100 can then process the sensor data as discussed above to determine vehicle events accordingly. When the vehicle 101 moves to a slope with a different inclination angle, the system 100 can re-calculate the rotation matrix R accordingly.

For instance, the UE 105 can lie flat on the floor of the vehicle 101 (e.g., FIG. 2E) and shares the same direction of motion and the z axis with the vehicle 101. FIG. 2H shows example rotation matric, according to various embodiments. In this instance, a two-dimensional (2D) the rotation matrix R2D can project a 2D vehicle event measurement vector (e.g., position, displacement, velocity, acceleration, etc.) in DFOR into another 2D vehicle event measurement vector in VFOR.

As another instance, the UE 105 sits on a holder in the vehicle 101 (e.g., FIG. 2B) and shares the same direction of motion but not the z axis with the vehicle 101. In this instance, a three-dimensional (3D) the rotation matrix R3D can project a 3D vehicle event measurement vector in DFOR into another 3D vehicle event measurement vector in VFOR.

Once the rotation matrix R is calculated (e.g., for the UE 105a in FIG. 2B), the system 100 can project a 3D vehicle event measurement vector \vec{v}_{device} (e.g., velocity, acceleration, etc.) based on sensor data collected by the UE 105 in DFOR to obtain a 3D vehicle event measurement vector \vec{v}_{vehicle} in VFOR using the rotation matrix R according to the equation (1). As shown in FIG. 2F, a rotation matrix 213 can virtually rotate the DFOR to align with VFOR, as if physically rotates the UE 105 to lie on the ground and point to a vehicle travel direction as the virtual UE 105v.

It is noted that the GPS receiver 107 and accelerometer 109 discussed with respect to the embodiments described herein are provided by way of illustration and not as limitations. It is contemplated that any other type of sensors that can provide information for deriving position changes, orientation changes, and/or acceleration can be used. For instance, in the absence of GPS sensor data, the system 100 can use any other two sensors among the accelerometer 109, the barometer 113, the magnetometer 111, etc. to obtain a plurality of pairs of time-matching datapoints of vehicle event measurement vectors measured using these sensors of the UE 105, to calculate and use the rotation matrix R as discussed. Based on the vehicle event measurement vectors projected into the VFOR, the system 100 can determine the relevant vehicle events, such as acceleration or deacceleration, forward or reverse motion, a turning event, a braking event, etc.

By way of examples, once the accelerometer readings are projected to the VFOR, the system 100 can interpret the projected accelerometer readings, for example, (1) to discern forward and reverse motion (any transition between the two requiring going through an idle state (zero velocity), (2) to discern forward/reverse motion corresponding to positive/negative acceleration in the y-axis in VFOR following an idle state, (3) to discerning acceleration from de-acceleration (e.g., if the vehicle in forward motion state, acceleration/de-acceleration corresponding to positive/negative acceleration in the y-axis VFOR), etc.

As mentioned, after the mobile sensor data collection phase 201, the system 100 can execute the data processing phase 203, the rotation matrix calculation phase 205, and the calibration and re-calibration phase 207. The following embodiments handle the data processing phase and the rotation matrix calculation phase differently depending on the presence or absence of GPS signals, considering the inclination angle α.

In The Presence of GPS Signals.

In the data processing phase 203, the system 100 can apply one or more filters (e.g., a Kalman filter or the like) location sensor data (e.g., GPS data) to obtain estimates and bounds of the velocity and acceleration of the vehicle 101 and/or the UE 105. The system 100 can take advantage of independent speed measurements based on the magnetic field in the vehicle. For instance, the system 100 can detect a vehicle speed using a frequency response of the magnetic field in the vehicle, since magnetometer is sensitive to changes in the magnetic field and the vehicle tires in most cases are steel-belted radial tires that tend to be magnetized. The net effect is that tires behave as rotating magnets such that the tire rotation frequency (related to speed) can be measured with the magnetometer. In one embodiment, when estimating kinematic properties (e.g., velocity, acceleration), the system 100 can use the full 3D trajectory (e.g., including location and height) from detailed map data.

In the rotation matrix calculation phase 205, the system 100 can match local VFOR data to the earth frame of reference (EFOR). Therefore, the system 100 can use road data to derive VFOR with respect to EFOR as follows. When digital map data (e.g., including latitude, longitude and altitude) is available, the system 100 can compute local gradients (slopes) by basic methods such as vector differential calculus. For instance, a local gradient can be calculated along a trajectory line. When setting a positive y-axis direction as along a road tangential unit vector, the negative z-axis direction is g·cos (α) relative to EFOR, and a is the inclination angle. The transverse x-axis can be the cross product of the y and z axes. The system 100 can then calculate a rotation matrix Re(EFOR→VFOR), e.g., from a north-east-up earth frame of reference to the vehicle frame of reference.

When the digital map data is unavailable, the system 100 can get the trajectory coordinates from the time-series of GPS data points (including latitude, longitude and altitude), and similarly derive the rotation matrix Re(EFOR→VFOR). When the altitude component is missing from the GPS data, the system 100 can use barometer/altimeter sensor data to derive the rotation matrix Re(EFOR VFOR). Since air pressure changes along the trajectory are linearly proportional to the altitude change, the barometer/altimeter sensor data reflects the inclination along the trajectory.

The system 100 can then calculate a full rotation matrix R is given by the equation:

R(DFOR→VFOR)=R(DFOR→EFOR)·R(EFOR→VFOR) (4)

In another embodiment, in order to account for numerical and measurement errors, the system 100 can average out over multiple measurements of the rotation matrix R. For instance, the deviations in pitch and roll are different among smartphone models, with mean inaccuracies per device of up to 2.1° and 6.6°, respectively.

Rather than standard elementwise averaging, the system 100 can keep the rotation matrix R orthonormal by, for example, taking the exponential representation of those matrices Rₖ=exp (θₖ), and the averaged rotation matrix is (R)=exp((θ)). In another embodiment, the system 100 can apply different weightings Wₖ on those matrices to obtain a weighted and averaged rotation matrix based on considerations, such as accelerometer and gyroscope bias and noise parameters. In another embodiment, the system 100 can exclude outliers from the matrices, then proceed with averaging and/or weightings. In another embodiment, the system 100 can apply historical calibrations (when historical rotation matrix(s) available, such as when UE 105 set on a permanent/fixed position like a phone holder in the vehicle 101) on the rotation matrix R, to improve the estimation.

As mentioned, the calibration process can starts immediately when a vehicle ride starts. In the calibration and re-calibration phase, the system 100 can apply the rotation matrix Ron newly connected mobile device sensor data into sensor data in the vehicle frame of reference as output to support mapping, navigation, car sharing, and other services. The system 100 can also repeat/re-calibrate as more mobile device senor data is collected, until the rotation matrix R converges, and/or the UE 105 has been reoriented (e.g., after being used).

In The Absence of GPS Signals.

In a more challenging scenario when no GPS signal is available, the system 100 can adapt the calibration process to perform the mobile sensor data collection phase 201, the data processing phase 203, and the rotation matrix calculation phase 205 differently. In the mobile sensor data collection phase, the system 100 does not collect location sensor data, nor rely on digital map data, yet still restricts vehicle movements to a single vehicle travel direction (e.g., a straight line such as the y axis of the VFOR 211) without lateral forces (such as from taking turns and/or lane changes), and/or on a slope with a constant or substantially constant inclination angle as discussed before.

In the data processing phase, the system 100 can filter accelerometer data collected by the UE 105 using a bandpass filter to remove the gravitational component (i.e., the linear acceleration along a motion direction of the vehicle 101) therefrom. For instance, the system 100 can estimate a direction of a gravity vector (e.g., a gravity pull: mg sin(α) in FIG. 2H) by (1) determining a direction of maximum acceleration (e.g., g in FIG. 2H) when the vehicle 101 is idle, (2) requiring the inclination angle α with respect to a plane perpendicular to a heading vector (e.g., the y axis in FIG. 2H) and pointing along the direction of maximum acceleration in the accelerometer 109, and (3) using the low-pass filter over the accelerometer data collected by the UE 105. After removing the gravitational component (e.g., a gravity pull: mg sin(α) in FIG. 2H) from the accelerometer data of the UE 105, only the acceleration component in the direction of motion (e.g., they axis in FIG. 2H) is left. The system 100 can get the velocity data considering the gravity pull, although not yet knowing the direction of motion being a positive or negative direction. To resolve this, the system 100 can use direct speed measurements using the magnetometer data as discussed above. Moreover, if the drive lasts for more than a few seconds and/or the speed is above some threshold, it is very likely that the vehicle is in forward motion.

In the rotation matrix calculation phase, the system 100 can calculate an optimal rotation matrix R(DFOR→VFOR), i.e., a direct transformation without involving the intermediate state of EFOR (when the GPS signals are available). While driving on relatively straight road stretches (without turns), the system 100 can use accelerometer data from the UE 105 in DFOR, to determine the VFOR y-axis as the center of mass for the measured linear acceleration (e.g., using a singular value decomposition (SVD)). SVD is a matrix decomposition method for reducing a matrix to its constituent parts in order to make certain subsequent matrix calculations simpler.

The system 100 can determine the VFOR z-axis by requiring it to be orthogonal to the y-axis and at the inclination angle α relative to the gravity vector in DFOR. The x-axis can be the result of a cross product between VFOR y-axis and the VFOR z-axis. In addition, during turns, the system 100 can detect the VFOR z-axis using gyroscope data from the UE 105, by identifying the direction of maximum energy (i.e., an axis of rotation). The system 100 can combine two estimations of the VFOR z-axis, to get better VFOR z-axis and/or rotation matrix with higher accuracy. Similarly, the averaging, weighting, and/or outliers processes as described can be used improve the resulting rotation matrix.

By way of example, the system 100 can detect and/or quantify vehicle turns and lane changes (each of which as two opposite small turn events) by (1) following the trajectory of the vehicle 101 using location sensors), or (2) using a standard sensor application programming interface (API) to obtain a rotation vector from a device frame of reference to a vehicle frame of reference, thereby obtaining the azimuthal and inclination angles.

The calibration and re-calibration phase 207 remains the same in the presence or absence of the GPS signals. The system 100 can apply the rotation matrix to calibrate mobile device sensor data from DFOR into VFOR, to support mapping, navigation, car sharing, and other services. For instance, once the system 100 computes the rotation matrix, it becomes straightforward to interpret accelerometer readings, by using Equation (1) to project the acceleration vector onto VFOR.

In another embodiment, the system 100 can distinguish among acceleration, deceleration from a reverse motion using a vehicle idle state. A vehicle idle state can be vehicle stop with engine off, vehicle idle with engine on, etc., to be determined via sensors and/or on-board control systems of the vehicle 101 (e.g., GPS readings and relevant speed information), and/or sensors in the UE 105 travelling with the vehicle 101. When GPS signal is unavailable (e.g., in underground parking, tunnels, or malfunctioning hardware), or low-quality signal (due to high rise buildings for instance), the system 100 can use UE sensors such as accelerometers, gyroscopes, and magnetometers to detect idle states of the vehicle. The system 100 can also detect the idle state via a vehicle speed using a frequency response of the magnetic field in the vehicle, thereby determining idle states of the vehicle (e.g., idle=speed zero). In yet another embodiment, the system 100 can detect barometric pressure gradient with sensitive pressure sensors (e.g., to detect several cm of height change), thereby determining idle states of the vehicle (e.g., idle=zero pressure gradient). In another embodiment, the system 100 can use sensor data of accelerometer(s) and/or gyroscope(s) to determine vibrations cause by a vehicle engine (e.g., an internal combustion engine), thereby determining idle states of the vehicle (e.g., idle=time-independent engine vibration).

For instance, to detect forward and reverse motions, the system 100 can detect any transition between forward and reverse motions that requires going through an idle state (e.g., zero velocity). In this instance, a forward/reverse motion will correspond to a positive/negative acceleration in the y-axis (in VFOR) following an idle state. As another instance, the system 100 can discerning acceleration from deceleration based on positive/negative acceleration in the y-axis (in VFOR). When the vehicle 101 is in forward motion state, acceleration corresponds to positive acceleration while deceleration corresponds to negative acceleration in the y-axis (in VFOR). As another instance, the system 100 can discern deceleration from a reverse motion by detecting an idle state between acceleration and deceleration and determining the deceleration as a reveres motion. On the hand, when there is no idle state between acceleration and deceleration during a forward motion, the deceleration can be braking).

In one embodiment, the system 100 can measure the inclination angle by tracking the height changes using barometer data. In other embodiments, the system 100 can use the pressure measurement to verify road stretches that are relatively inclination-free and therefore the gravitation direction coincides with the z-axis.

In short, the system 100 can provide mobile device sensor based awareness, i.e., using physical sensor information from a mobile device (e.g., UE 105) for cognition without knowledge of the location/orientation of the mobile device with respect to the vehicle, by calibrating the mobile device sensor data from DFOR to VFOR, in the presence or absence of location data (e.g., GPS signals, map data, etc.). As a result, the system 100 can generate qualitative and/or quantitative descriptions of events taking place while operating a vehicle. The vehicle events may include starting a vehicle, stopping, passenger on/off boarding, vehicle turning, taking a ramp, braking or accelerating, etc. in various operation context (e.g., regular driving, stopping, parking, etc.).

In one embodiment, the various embodiments described herein support more accurate navigation and/or other location-based services by providing vehicle event data 121, especially when GNSS data is unavailable or sparse. For example, the vehicle event data 121 can be provided by the system 100 as an output to initiate a visual presentation (e.g., a turning or braking light) to indicate a detected vehicle event. In another embodiment, the system 100 can initiate an audio presentation (e.g., a turning or braking alarm) to indicate the detected vehicle event.

In other embodiments, the vehicle event data 121 can be provided by the system 100 as an output over a communications network 123 to a service platform 125 including one or more services 127a-127k (also referred to as services 127). As discussed above, the services 127 can include, but are not limited to, mapping services, navigation services, and/or the like that can combine the vehicle event data 121 with digital map data (e.g., a geographic database 129) to provide location-based services, such as high definition map data services (e.g., supporting autonomous driving). It is also contemplated that the services 127 can include any service that uses the vehicle event data 121 to provide or perform any function. In one embodiment, the vehicle event data 121 can also be used by one or more content providers 131a-131j (also collectively referred to as content providers 131). These content providers 131 can aggregate and/or process the vehicle event data 121 to provide the processed data to its users such as the service platform 125 and/or services 127.

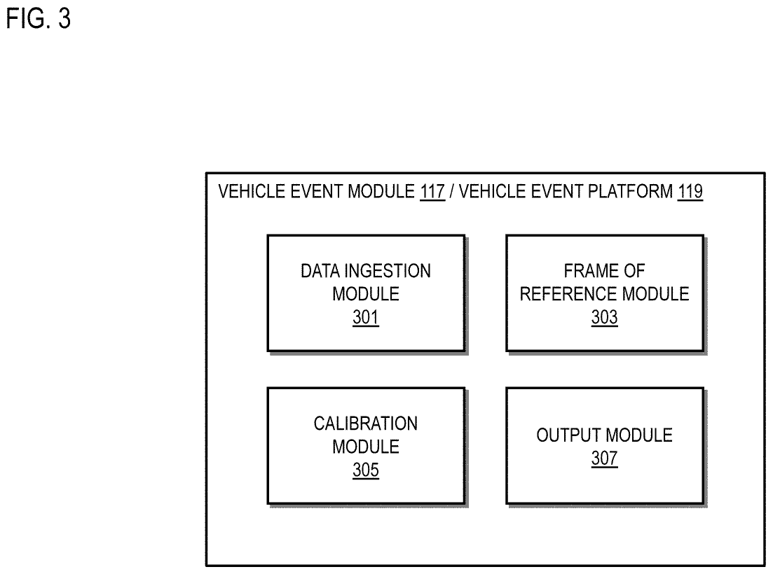

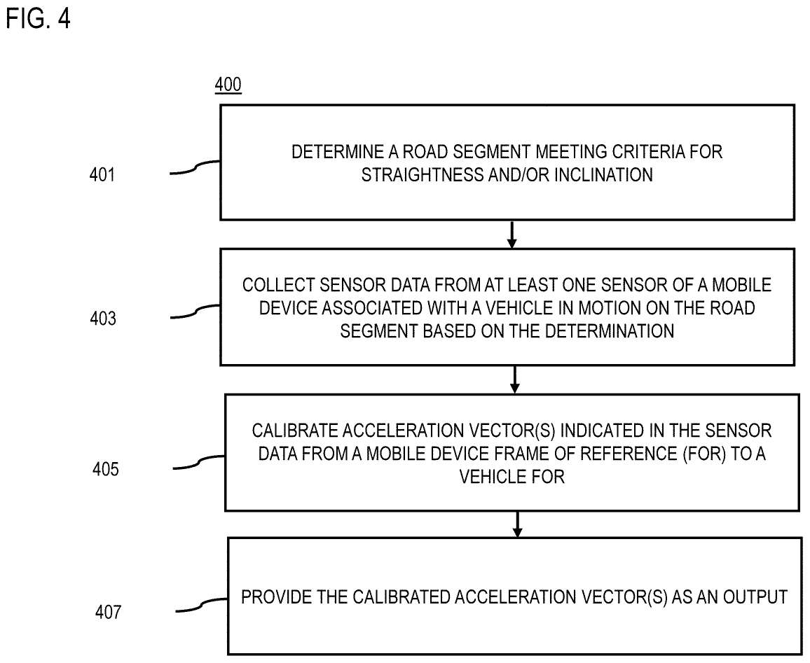

FIG. 3 is a diagram of a vehicle event module/vehicle event platform capable of calibrating vehicle motion data using a rotation matrix calculated based on mobile device sensor data, according to one embodiment. In one embodiment, the vehicle event module 117 (e.g., a local component) and/or vehicle event platform 119 (e.g., a network/cloud component) may perform one or more functions or processes associated with determining vehicle events based on mobile device sensor data or equivalent sensor data. By way of example, as shown in FIG. 3, the vehicle event module 117 and/or vehicle event platform 119 include one or more components for performing functions or processes of the various embodiments described herein. It is contemplated that the functions of these components may be combined or performed by other components of equivalent functionality. In one embodiment, the vehicle event module 117 and/or vehicle event platform 119 include a data ingestion module 301, a frame of reference module 303, a calibration module 305, and an output module 307. The above presented modules and components of the vehicle event module 117 and/or vehicle event platform 119 can be implemented in hardware, firmware, software, or a combination thereof. In one embodiment, the vehicle event module 117, vehicle event platform 119, and/or any of their modules 301-307 may be implemented as a cloud-based service, local service, native application, or combination thereof. The functions of vehicle event module 117, vehicle event platform 119, and modules 301-307 are discussed with respect to FIGS. 4-6 below.

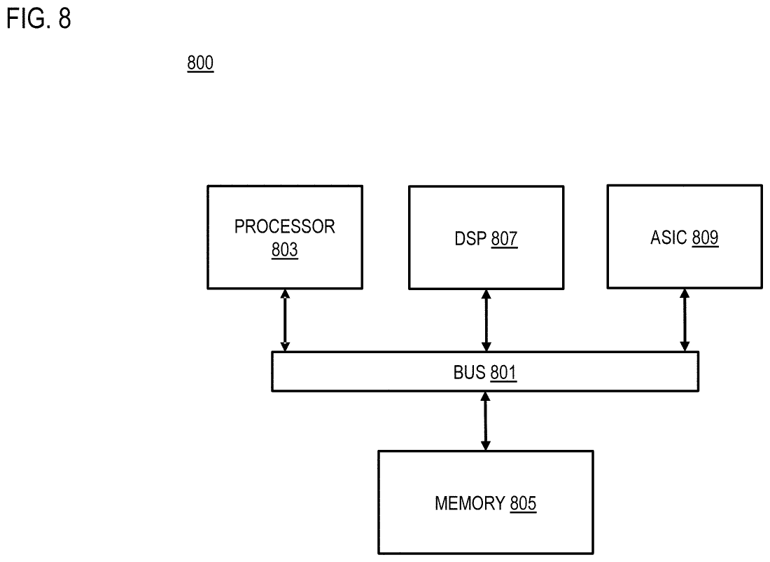

FIG. 4 is a flowchart of a process for calibrating vehicle motion data using a rotation matrix calculated based on mobile device sensor data, according to one embodiment. In various embodiments, the vehicle event module 117, vehicle event platform 119, and/or any of their modules 301-307 may perform one or more portions of the process 400 and may be implemented in, for instance, a chip set including a processor and a memory as shown in FIG. 8. As such, the vehicle event module 117, vehicle event platform 119, and/or any of their modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the process 400 can provide a practical approach for detecting vehicle events using sensor data from a mobile device (e.g., UE 105). As mentioned, a position and an orientation of the UE 105 with respect to the vehicle 101 is generally unknown. Referring back to FIGS. 2B-2E, when a UE 105 is placed in the vehicle 101, the axes of the device frame of refence 209 and the vehicle frame of reference 211 generally do not overlap (e.g., FIG. 2F), and the rotation matrix 213 between those two sets of axes is apriori unknown. To figure out a direction of travel of the vehicle 101, e.g., forward, backward, or sideway, the system 100 can calculate a rotation matrix R that can project vehicle event measurement vectors in a device frame of reference to a vehicle frame of reference, without the knowledge of the mobile device setup (e.g., orientation and location) relative to the vehicle 101, thereby detecting the vehicle event of the vehicle 101 which the mobile device (e.g., a UE 105 installed with the IMU 115) is travelling with.

For example, in step 401, the data ingestion module 301 can determine a road segment that meets one or more criteria for straightness, inclination, or a combination thereof. By way of example, the criteria can include straight and flat stretches of road (to avoid lateral forces from turns, lane changes, etc.), on a slope with a constant or substantially constant inclination angle, etc.

For example, the data ingestion module 301 can determine sensor data (e.g., the sensor data 103) from at least one sensor of a mobile device (e.g., UE 105) associated with a vehicle (e.g., the vehicle 101) in motion along a known direction of travel on a road. In one embodiment the road is “horizontal”, with either a zero inclination or an inclination within a designated range around a zero inclination. For instance, the sensor data 103 can be collected over relatively straight and flat stretches of road to avoid lateral forces from turns, lane changes, etc. If lateral forces were included, the data ingestion module 301 can identify and exclude/filter them from the subsequent steps. In one embodiment the road is a slope with either a substantially constant inclination angle or an inclination variation within a designated range near zero.

In one embodiment, in step 403, the data ingestion module 301 can collect sensor data (e.g., the sensor data 103) from at least one sensor (e.g., the GPS receivers 107, the accelerometer 109, the magnetometer 111, the barometer 113, etc.) of a mobile device (e.g., the UE 105) associated with a vehicle (e.g., the vehicle 101) in motion on the road segment based on the determination. For instance, the sensor data can indicates one or more acceleration vectors in a mobile device frame of reference (e.g., the DFOR 209 in FIG. 2F).

The known direction of travel can a forward direction, a reverse direction, or other directions, and the data ingestion module 301 can convert the sensor values t, a(t), w(t), m(t), h(t), etc. into linear velocity v(t), turning angle value Θ(t), height change (t), vertical velocity vh(t), etc. and set them into, for example, one or more acceleration vectors (e.g., \vec{a}_{loc}, \vec{a}ᵢₘᵤ) in a mobile device frame of reference at a time point t. In one embodiment, the data ingestion module 301 can generate a plurality of pairs of time-matching datapoints \vec{a}_{loc} (t), \vec{a}ᵢₘᵤ (t), of the one or more acceleration vectors \vec{a}_{loc} (t), \vec{a}ᵢₘᵤ (t). The magnitude of those vectors should be similar up to measurement and numerical errors, and the data ingestion module 301 can exclude outlying data points.

In one embodiment, the data ingestion module 301 can retrieve map data (e.g., digital map data) representing the road segment, and the determination of the straightness, the inclination, or a combination of the road segment can be based on the map data. When calculating/estimating the kinematic properties (e.g., velocity, acceleration), in one embodiment, the data ingestion module 301 can retrieve full 3D trajectory data (e.g., location and height) in detailed map information, from example, from a map database.

When the map data is unavailable, the data ingestion module 301 can collect location sensor data from one or more location sensors (e.g., the GPS receiver 107) of the mobile device 105, the vehicle 101, or a combination thereof, and the determination of the straightness, the inclination, or a combination of the road segment can be based on the location sensor data.

In another embodiment, the data ingestion module 301 can collect pressure sensor data from one or more pressure sensors (e.g., the barometer 113) of the mobile device 105, the vehicle 101, or a combination thereof, and the determination of the straightness, the inclination, or a combination of the road segment can be based on the pressure sensor data.

In one embodiment, the data ingestion module 301 can initiate a filtering (e.g., a Kalman filter) of the one or more acceleration vectors to remove a gravitational component (e.g., the gravity pull: mg sin(α) in FIG. 2G), and the calibrating can be performed on the one or more filtered acceleration vectors. The Kalman filter can use a series of sensor data observed over time, and estimate a joint probability distribution of velocity and acceleration values for each timeframe. In another embodiment, the data ingestion module 301 can use independent speed measurements based on the magnetic field output from the magnetometer 111 to calculate the velocity and acceleration values.

In another embodiment, the data ingestion module 301 can initiate a filtering of the accelerometer data (e.g., using a bandpass filter) to remove a gravitational component (e.g., in the direction (0, 0, 1) in VFOR in FIG. 2F), to match a sampling frequency of the location information (e.g., GPS data), or a combination thereof.

In one embodiment, in step 405, the calibration module 305 can calibrate the one or more acceleration vectors from the mobile device frame of reference (e.g., the DFOR 209 in FIG. 2F) to a vehicle frame of reference (e.g., the VFOR 211 in FIG. 2F) based on the sensor data. For instance, a position and an orientation of the mobile device (e.g., UE 105) with respect to the vehicle 101 is unknown (e.g., as shown in FIGS. 2B-2E).

In another embodiment, for a plurality of location points on the road segment, the frame of reference module 303 can calculate a respective rotation matrix from the mobile device frame of reference (DFOR) to the vehicle frame of reference (VFOR) based on the one or more acceleration vectors, and average the respective rotation matric (e.g., Rₖ), into an averaged rotation matrix(e.g., (R)=exp((Θ))) over the plurality of location points. The one or more acceleration vectors can be calibrated using the averaged rotation matrix. For instance, the averaging can comprise taking an exponential representation of the respective rotation matrix (e.g., Rₖ=exp (θₖ)), applying weightings Wk on the respective rotation matric Rₖ, excluding one or more outliers from the respective rotation matric, or a combination thereof. For instance, initial values of elements of the averaged rotation matrix can be determined based on historical calibration data, such as the last used rotation matrix, the most popular rotation matrix during a recent time frame (e.g., when using a rotatable phone holder), an averaged rotation matrix calculated when UE 105 set on a permanent/fixed position like a phone holder in the vehicle 101, the most popular rotation matrix during the recent time frame, etc. across all mobile devices in this vehicle 101, etc. The frame of reference module 303 then can recalculate the rotation matrix until the rotation matrix converges to within a threshold amount.

In one embodiment, the frame of reference module 303 can determine the elements of the rotation matrix based on sensor data including location information (e.g., from the GPS receiver 107) and accelerometer data (e.g., from the accelerometer 109), etc., and the plurality of pairs of time-matching datapoints can include a plurality of pairs of time-matching location and accelerometer datapoints of the location information and the accelerometer data.

In another embodiment, the frame of reference module 303 can calculate a rotation matrix while driving on an horizontal road by setting the z-axis of the one or more acceleration vectors \vec{a}_{loc}(t), \vec{a}ᵢₘᵤ(t) to coincide with a gravitation direction (e.g., the direction (0, 0, 1) in VFOR in FIG. 2F) as measured in the sensor data 103 and to determine a best match between elements of the rotation matrix R and the plurality of pairs of time-matching datapoints \vec{a}_{loc}(t), \vec{a}ᵢₘᵤ (t). For example, the known direction of travel is a forward direction (e.g., the direction (0, 1, 0) in VFOR 211 in FIG. 2F). In the forward motion, the rotation matrix R (e.g., the rotation matrix 213 in FIG. 2F) can project velocity/acceleration vector points (e.g., VD in DFOR 209 in FIG. 2F) into the y-direction (e.g., of VFOR 211 in FIG. 2F). The x-z axes are perpendicular to the y-axis, but the mobile device orientation is arbitrary, as there is no car acceleration in those axes. This ambiguity is removed when using sensor data points collected on flat roads (e.g., with zero inclination), where the z-axis is set to coincide with the gravitation direction as measured by the raw accelerometer data.

In another embodiment, the frame of reference module 303 can calculate a rotation matrix while driving on inclined roads (e.g., a slope in FIG. 2G) considering the inclination angle α by removing/filtering a gravitational component (e.g., the gravity pull: mg sin(α) in FIG. 2G) from the rotation matrix R. When a vehicle is on a slope, the direction of gravity is no longer the Z-axis of the vehicle. The system 100 can assume the vehicle O is moving on a slope (tangent plane) with inclination angle of a, and its heading direction at angle θ (e.g., =0 in FIG. 2G) to the direction of slope. a=(at, an) the vehicle's tangential and radial accelerations. Assume the 3 axes of the vehicle's coordinate system are XV, YV and ZV. First the gravity direction is obtained using a mobile OS APIs that use low-pass filters to remove high frequency components caused by rotation and translation movements. It is assumed to be the direction of ZV in the UE's coordinate system (i.e., vehicles moving on level ground). Next the gravity direction component is deducted to obtain the acceleration on the horizontal plane. The direction of maximum acceleration (caused by vehicle accelerating or decelerating) is estimated as YV (i.e., forward direction). Finally, XV is determined as the cross product of YV and ZV using the right-hand rule. The XV, YV and ZV directions in the UE's coordinate system give a rotation matrix that converts the UE's acceleration into that of the vehicle's acceleration.

In an indoor parking or tunnel scenario, the GPS data is usually inaccurate and sampled at a frequency which is too low to be useful for such detailed analysis of parking maneuvers, etc. In the absence of the GPS data, it is hard to tell whether accelerometer reading represents acceleration/deacceleration or a reverse motion. In one embodiment, when driving in places where location sensor data (e.g., GPS signals) is unavailable or inaccurate (e.g., indoor parking lots), the data ingestion module 301 can verify that the vehicle travels on a flat stretch based on the barometer data and on a straight stretch in the absence of turns, without location data and map information. The data ingestion module 301 can also measure the road inclination of the UE 105 by tracking the height changes based on the barometer data. By way of example, the data ingestion module 301 can use only the pressure measurement to verify road stretches that are relatively inclination-free or at a near constant inclination angle, and therefore the gravitation direction with respect to the z-axis. As another example, the data ingestion module 301 can directly derive from the magnetometer data a direction of travel as a forward or backward direction. As yet another example, the data ingestion module 301 can calculate a speed from a magnetic response.

The frame of reference module 303 can then determine the elements of the rotation matrix based on sensors of the IMU 115 without the location sensor data. As discussed, the data ingestion module 301 can filter accelerometer data is with a bandpass filter to remove a gravitational component thereof, to match a sampling frequency of the barometer data, etc. before calculating the optimal rotation matrix.

In one embodiment, the frame of reference module 303 can determine the optimal rotation matrix based on sensor data including barometer data and accelerometer data, and the plurality of pairs of time-matching datapoints include a plurality of pairs of time-matching location and accelerometer datapoints of the barometer data and the accelerometer data. The only left acceleration component is assumed to be in the direction of travel. The frame of reference module 303 can process these acceleration vectors as discussed in conjunction with \vec{a}_{loc}(t), \vec{a}ᵢₘᵤ (t) to calculate the rotation matrix. The calibration module 305 can then project acceleration vectors of interest with the rotation matrix from the mobile device frame of reference to a vehicle frame of reference associated with the vehicle as discussed.

In one embodiment, the calibration module 305 can project the one or more acceleration vectors from the mobile device frame of reference (e.g., DFOR 209 in FIG. 2F) to a vehicle frame of reference (e.g., VFOR 211 in FIG. 2F) associated with the vehicle based on the rotation matrix (e.g., the rotation matrix 213 in FIG. 2F). In another embodiment, the calibration module 305 can use the rotation matrix to project subsequent sensor data collected from the at least one sensor from the mobile device frame of reference to the vehicle frame of reference. By way of example, once the rotation matrix is obtained, measured accelerations by the accelerometer 109 in DFOR can be projected on the VFOR.

In order to account for numerical and measurement errors of the sensor data 103, the frame of reference module 303 can formulate the computation of the rotation matrix elements as an optimization problem to produce the best match over all time-matching data pairs (with unitarity constraints). In one embodiment, the best match is determined based on a cost function. For instance, the cost function can be based on a deviation of the projected one or more acceleration vectors form an axis of the vehicle frame of reference, for example, the cosine of the deviation of the resulting acceleration from the VFOR y-axis in FIG. 2F.

In another embodiment, the frame of reference module 303 can initiate a re-calculation of the respective rotation matrix based on a detected change in a position, an orientation, or a combination thereof of the mobile device 105. For instance, the re-calculation process of the rotation matrix R can be triggered in various circumstances that change the position and/or orientation of the UE 105, such as a turn or lane change.

In one embodiment, the data ingestion module 301 working in conjunction with the frame of reference module 303 can initiate the collecting of the sensor data, the calculating of the respective rotation matrix, or a combination thereof based on detecting a start of a trip by the vehicle 101. The data ingestion module 301 working in conjunction with the frame of reference module 303 can repeat the collecting of the sensor data, the calculating of the respective rotation matrix, or a combination thereof until the averaged rotation matrix converges to within a threshold amount.

In one embodiment, in step 407, the output module 307 can provide the one or more calibrated acceleration vectors as an output. In one embodiment, the output module 307 can detect a forward or reverse motion of the vehicle, an acceleration or deceleration of the vehicle, or a combination thereof based on the calibrated one or more acceleration vectors. In another embodiment, the output module 307 can determine an idle state of the vehicle based on the sensor data, and distinguish an deceleration or a reverse motion of the vehicle based on the idle state.

Once the accelerometer readings are projected to the VFOR, based a value of the y component, the output module 307 can determine if its acceleration or deacceleration. By combining additional information about vehicle idle states, the output module 307 can discern deacceleration from a reverse motion. By way of example, the output module 307 can interpret the projected accelerometer readings, for example, (1) to discern forward and reverse motion (any transition between the two requires going through an idle state (zero velocity), (2) to discern forward/reverse motion corresponding to positive/negative acceleration in the y-axis in VFOR following an idle state, (3) to discerning acceleration from de-acceleration (e.g., if the vehicle in forward motion state, acceleration/de-acceleration corresponding to positive/negative acceleration in the y-axis VFOR), etc.

The output, for instance, can be provided or transmitted to any service, application, function, component, system, device, or equivalent that requests the vehicle event data. For example, the vehicle event output can be provided to the service platform 125, any of the services 127 (e.g., autonomous driving services), any of the content providers 131, and/or the like.

In another embodiment, the output module 307 can provide mobile sensor data and/or vehicle event data via various audio, visual, touch, etc. via user interfaces of the UE 105. For instance, the output module 307 can generate and render qualitative and/or quantitative descriptions of events taking place while operating a vehicle via audio, visual, touch, etc. user interfaces. The vehicle events may include starting a vehicle, stopping, passenger on/off boarding, vehicle turning, taking a ramp, braking or accelerating, etc. in various operation context (e.g., regular driving, stopping, parking, etc.). Such vehicle event information can be used, for example, in parking event analysis in finer details, such as parking in parallel or perpendicular to the road, parking in reverse or in forward drive etc.

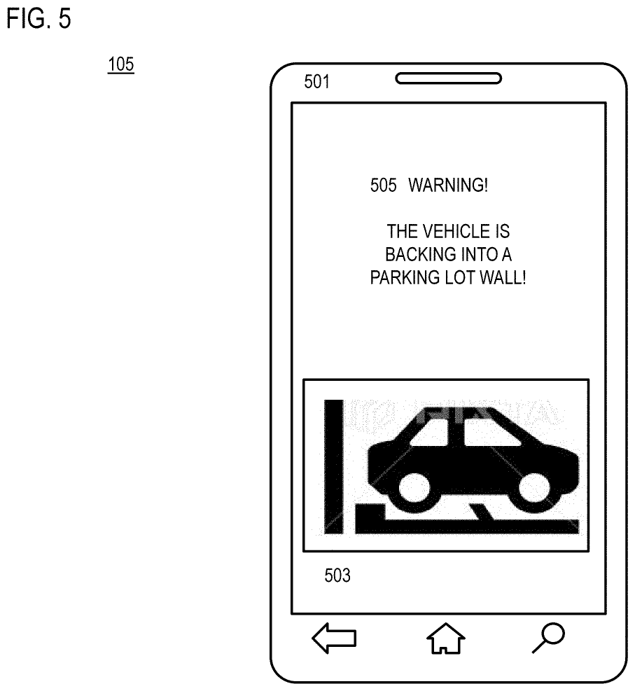

By way of example, the output module 307 can present/visualize a vehicle event on a user interface. FIG. 5 is a diagram of an example user interface showing a vehicle event, according to one embodiment. In this example, the UI 501 shown may be generated for a UE 105 that depicts a vehicle event 503 (e.g., backing into a wall) and an alert 505 to indicate the detected vehicle event: “Warning! The vehicle is backing into a parking lot wall!”. In addition, the UE 105 can initiate an audio presentation of the alert to indicate the detected vehicle event. By way of example, the audio alert may be a recorded loud vehicle braking sound.

Returning to FIG. 1, the system 100 comprises one or more vehicles 101 associated with one or more UEs 105 having respective vehicle event modules 117 and/or connectivity to the vehicle event platform 119. By way of example, the UEs 105 may be a personal navigation device (“PND”), a cellular telephone, a mobile phone, a personal digital assistant (“PDA”), a watch, a camera, a computer, an in-vehicle or embedded navigation system, and/or other device that is configured with multiple sensor types (e.g., GPS receivers 107, accelerometers 109, etc.) that can be used for determined vehicle speed according to the embodiments described herein. It is contemplated, that the UE 105 (e.g., cellular telephone or other wireless communication device) may be interfaced with an on-board navigation system of an autonomous vehicle or physically connected to the vehicle 101 for serving as a navigation system. Also, the UEs 105 and/or vehicles 101 may be configured to access the communications network 123 by way of any known or still developing communication protocols. Via this communications network 123, the UEs 105 and/or vehicles 101 may transmit sensor data collected from IMU or equivalent sensors for facilitating vehicle speed calculations.

The UEs 105 may be configured with multiple sensors of different types for acquiring and/or generating sensor data according to the embodiments described herein. For example, sensors may be used as GPS or other positioning receivers for interacting with one or more location satellites to determine and track the current speed, position and location of a vehicle travelling along a roadway. In addition, the sensors may gather IMU data, NFC data, Bluetooth data, acoustic data, barometric data, tilt data (e.g., a degree of incline or decline of the vehicle during travel), motion data, light data, sound data, image data, weather data, temporal data and other data associated with the vehicle and/or UEs 105 thereof. Still further, the sensors may detect local or transient network and/or wireless signals, such as those transmitted by nearby devices during navigation of a vehicle along a roadway. This may include, for example, network routers configured within a premise (e.g., home or business), another UE 105, or a communicable traffic system (e.g., traffic lights, traffic cameras, traffic signals, digital signage).

By way of example, the vehicle event module 117 and/or vehicle event platform 119 may be implemented as a cloud-based service, hosted solution or the like for performing the above described functions. Alternatively, the vehicle event module 117 and/or vehicle event platform 119 may be directly integrated for processing data generated and/or provided by the service platform 125, one or more services 127, and/or content providers 131. Per this integration, the vehicle event platform 119 may perform client-side state computation of vehicle speed data.

By way of example, the communications network 123 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

A UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that a UE 105 can support any type of interface to the user (such as “wearable” circuitry, etc.).

By way of example, the UE 105s, the vehicle event module 117/vehicle event platform 119, the service platform 125, and the content providers 131 communicate with each other and other components of the communications network 123 using well known, new or still developing protocols. In this context, a protocol includes a set of rules defining how the network nodes within the communications network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

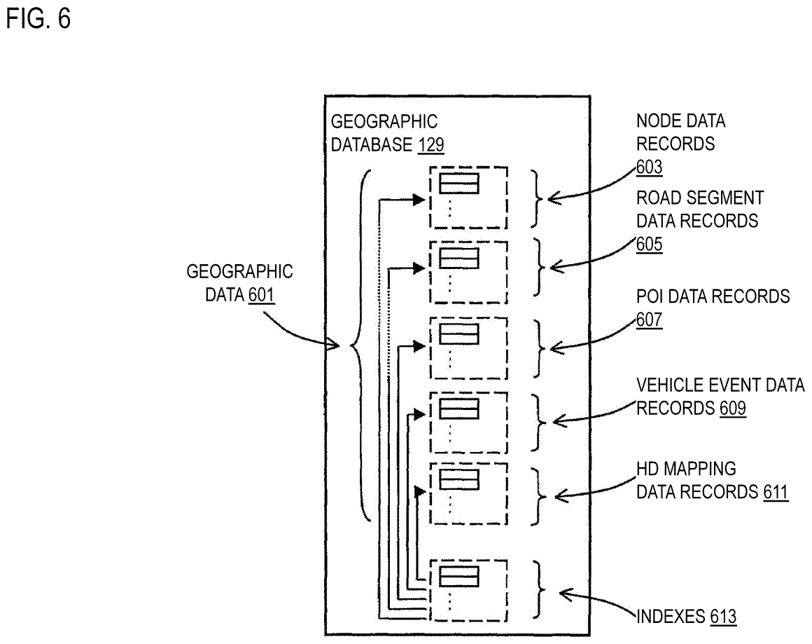

FIG. 6 is a diagram of a geographic database (such as the database 129), according to one embodiment. In one embodiment, the geographic database 129 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 129 include high resolution or high definition (HD) mapping data that provide centimeter-level or better accuracy of map features. For example, the geographic database 129 can be based on Light Detection and Ranging (LiDAR) or equivalent technology to collect billions of 3D points and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 129.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 129 follows certain conventions. For example, links do not cross themselves and do not cross each other except at a node. Also, there are no duplicated shape points, nodes, or links. Two links that connect each other have a common node. In the geographic database 129, overlapping geographic features are represented by overlapping polygons. When polygons overlap, the boundary of one polygon crosses the boundary of the other polygon. In the geographic database 129, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 129 includes node data records 603, road segment or link data records 605, POI data records 607, vehicle event data records 609, mapping data records 611, and indexes 613, for example. More, fewer or different data records can be provided. In one embodiment, additional data records (not shown) can include cartographic (“carto”) data records, routing data, and vehicle event data. In one embodiment, the indexes 613 may improve the speed of data retrieval operations in the geographic database 129. In one embodiment, the indexes 613 may be used to quickly locate data without having to search every row in the geographic database 129 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, cars, and/or other entities. Alternatively, the geographic database 129 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 129 can include data about the POIs and their respective locations in the POI data records 607. The geographic database 129 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 129 can also include vehicle event data records 609 for storing mobile device sensor data, historical calibration data, rotation matrix data, rotation matrix prediction models, annotated observations, computed mobile device location/orientation distributions, sampling probabilities, and/or any other data generated or used by the system 100 according to the various embodiments described herein. By way of example, the vehicle event data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 129 can be maintained by the content provider 131 in association with the services platform 117 (e.g., a map developer). The map developer can collect geographic data to generate and enhance the geographic database 129. There can be different ways used by the map developer to collect data. These ways can include obtaining data from other sources, such as municipalities or respective geographic authorities. In addition, the map developer can employ field personnel to travel by vehicle (e.g., vehicles 101 and/or user terminals 105) along roads throughout the geographic region to observe features and/or record information about them, for example. Also, remote sensing, such as aerial or satellite photography, can be used.

The geographic database 129 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a user terminal 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for calibrating vehicle motion data using a rotation matrix calculated based on mobile device sensor data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

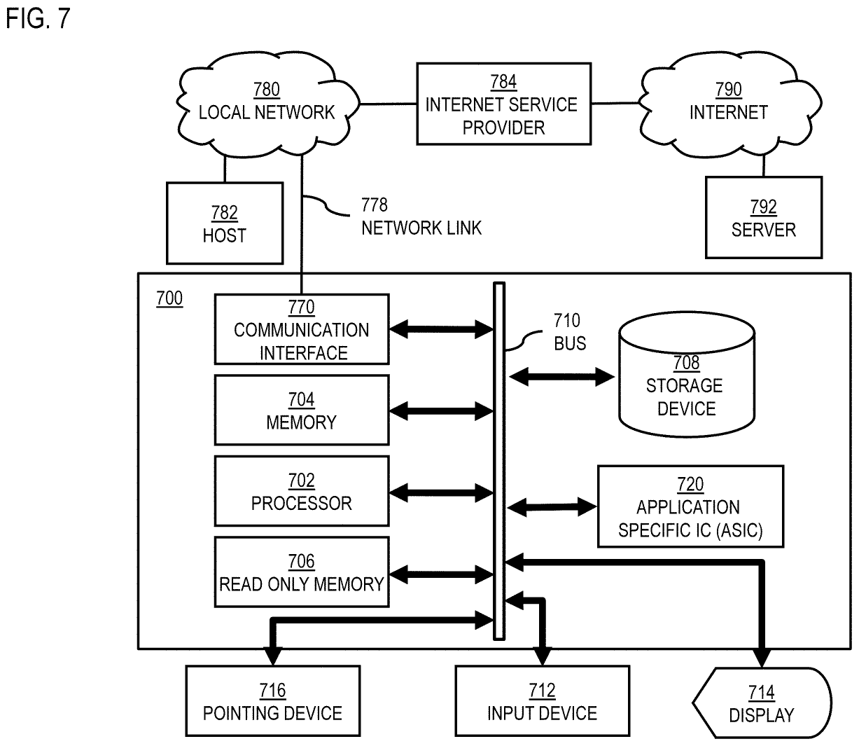

FIG. 7 illustrates a computer system 700 upon which an embodiment of the invention may be implemented. Computer system 700 is programmed (e.g., via computer program code or instructions) to calibrate vehicle motion data using a rotation matrix calculated based on mobile device sensor data as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to calibrating vehicle motion data using a rotation matrix calculated based on mobile device sensor data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for calibrating vehicle motion data using a rotation matrix calculated based on mobile device sensor data. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for calibrating vehicle motion data using a rotation matrix calculated based on mobile device sensor data, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 123 for determining vehicle events using a rotation matrix calculated based on sensor data from the UE 105.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to calibrate vehicle motion data using a rotation matrix calculated based on mobile device sensor data as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to calibrate vehicle motion data using a rotation matrix calculated based on mobile device sensor data. The memory 805 also stores the data associated with or generated by the execution of the inventive steps.

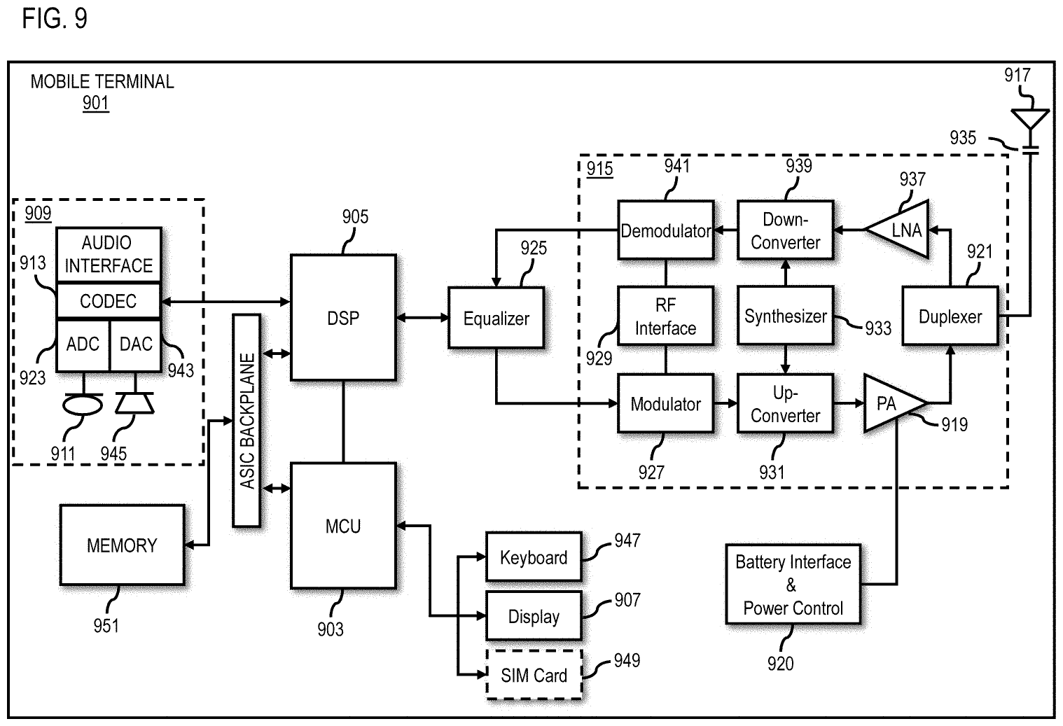

FIG. 9 is a diagram of exemplary components of a mobile terminal 901 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to calibrate vehicle motion data using a rotation matrix calculated based on mobile device sensor data. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a road segment that meets one or more criteria for straightness, inclination, or a combination thereof;
collecting sensor data from at least one sensor of a mobile device associated with a vehicle in motion on the road segment based on the determination, wherein the sensor data indicates one or more acceleration vectors in a mobile device frame of reference;
calibrating the one or more acceleration vectors from the mobile device frame of reference to a vehicle frame of reference based on the sensor data; and
providing the one or more calibrated acceleration vectors as an output.

2. The method of claim 1, further comprising:
retrieving map data representing the road segment,
wherein the determination of the straightness, the inclination, or a combination of the road segment is based on the map data.

3. The method of claim 1, further comprising:
collecting pressure sensor data from one or more pressure sensors of the mobile device, the vehicle, or a combination thereof,
wherein the determination of the straightness, the inclination, or a combination of the road segment is based on the pressure sensor data.

4. The method of claim 1, further comprising:
collecting location sensor data from one or more location sensors of the mobile device, the vehicle, or a combination thereof,
wherein the determination of the straightness, the inclination, or a combination of the road segment is based on the location sensor data.

5. The method of claim 1, further comprising:
initiating a filtering of the one or more acceleration vectors to remove a gravitational component,
wherein the calibrating is performed on the one or more filtered acceleration vectors.

6. The method of claim 1, further comprising:
for a plurality of location points on the road segment, calculating a respective rotation matrix from the mobile device frame of reference to the vehicle frame of reference based on the one or more acceleration vectors; and
averaging the respective rotation matric into an averaged rotation matrix over the plurality of location points,
wherein the one or more acceleration vectors are calibrated using the averaged rotation matrix.

7. The method of claim 6, wherein the averaging comprises taking an exponential representation of the respective rotation matric, applying weightings on the respective rotation matric, excluding one or more outliers from the respective rotation matric, or a combination thereof.

8. The method of claim 6, further comprising:
initiating a re-calculation of the respective rotation matrix based on a detected change in a position, an orientation, or a combination thereof of the mobile device.

9. The method of claim 6, wherein initial values of elements of the averaged rotation matrix is determined based on historical calibration data.

10. The method of claim 6, further comprising:
initiating the collecting of the sensor data, the calculating of the respective rotation matrix, or a combination thereof based on detecting a start of a trip by the vehicle.

11. The method of claim 10, further comprising:
repeating the collecting of the sensor data, the calculating of the respective rotation matrix, or a combination thereof until the averaged rotation matrix converges to within a threshold amount.

12. The method of claim 1, further comprising:
detecting a forward or reverse motion of the vehicle, an acceleration or deceleration of the vehicle, or a combination thereof based on the calibrated one or more acceleration vectors.

13. The method of claim 12, further comprising:
determining an idle state of the vehicle based on the sensor data; and
distinguishing an deceleration or a reverse motion of the vehicle based on the idle state.

14. The method of claim 1, wherein a position and an orientation of the mobile device with respect to the vehicle is unknown.

15. An apparatus comprising:
at least one processor; and
at least one memory including computer program code for one or more programs,
the at least one memory and the computer program code configured to, with the at least one processor, cause the apparatus to perform at least the following,
determine a road segment that meets one or more criteria for straightness, inclination, or a combination thereof;
collect sensor data from at least one sensor of a mobile device associated with a vehicle in motion on the road segment based on the determination, wherein the sensor data indicates one or more acceleration vectors in a mobile device frame of reference;
calibrate the one or more acceleration vectors from the mobile device frame of reference to a vehicle frame of reference based on the sensor data; and
provide the one or more calibrated acceleration vectors as an output.

16. The apparatus of claim 15, wherein the apparatus is further caused to:
retrieve map data representing the road segment,
wherein the determination of the straightness, the inclination, or a combination of the road segment is based on the map data.

17. The apparatus of claim 15, wherein the apparatus is further caused to:
collect pressure sensor data from one or more pressure sensors of the mobile device, the vehicle, or a combination thereof,
wherein the determination of the straightness, the inclination, or a combination of the road segment is based on the pressure sensor data.

18. A non-transitory computer-readable storage medium carrying one or more sequences of one or more instructions which, when executed by one or more processors, cause an apparatus to perform:
determining a road segment that meets one or more criteria for straightness, inclination, or a combination thereof;
collecting sensor data from at least one sensor of a mobile device associated with a vehicle in motion on the road segment based on the determination, wherein the sensor data indicates one or more acceleration vectors in a mobile device frame of reference;
calibrating the one or more acceleration vectors from the mobile device frame of reference to a vehicle frame of reference based on the sensor data; and
providing the one or more calibrated acceleration vectors as an output.

19. The non-transitory computer-readable storage medium of claim 18, wherein the apparatus is caused to further perform:
retrieving map data representing the road segment,
wherein the determination of the straightness, the inclination, or a combination of the road segment is based on the map data.

20. The me non-transitory computer-readable storage medium of claim 18, wherein the apparatus is caused to further perform:
collecting pressure sensor data from one or more pressure sensors of the mobile device, the vehicle, or a combination thereof,
wherein the determination of the straightness, the inclination, or a combination of the road segment is based on the pressure sensor data.
